(19) United States
(12) Patent Application Publication
(10) Pub. No.: US 2024/0139713 A1
(43) Pub. Date: May 2, 2024

(54) MULTI-COMPONENT SURFACE CHEMISTRY TO ELIMINATE RETENTION LOSS IN REVERSED-PHASE LIQUID CHROMATOGRAPHY

(71) Applicant: Waters Technologies Corporation, Milford, MA (US)

(72) Inventor: Fabrice Gritti, Franklin, MA (US)

(73) Assignee: Waters Technologies Corporation, Milford, MA (US)

(21) Appl. No.: 18/497,428

(22) Filed: Oct. 30, 2023

Related U.S. Application Data
(60) Provisional application No. 63/420,870, filed on Oct. 31, 2022.

(51) Int. Cl. B01J 20/286; B01D 15/30; B01D 15/32; B01D 15/36; B01D 15/38; B01J 20/28; B01J 20/32; G01N 30/34; G01N 30/46

(52) U.S. Cl. CPC B01J 20/286; B01D 15/305; B01D 15/327; B01D 15/361; B01D 15/3847; B01J 20/28092; B01J 20/28097; B01J 20/3285; G01N 30/34; G01N 30/463; B01J 2220/54; G01N 2030/528

(57) ABSTRACT

Provided herein is a multi-component chromatographic material and use thereof for reversed-phase liquid chromatography. The multi-component chromatographic materials provided herein comprise a chromatographic core having an exterior surface; and at least two different hydrophobic ligands covalently bound to the exterior surface with a total surface coverage less than 2.0 μmol/m². The multi-component chromatographic materials of the present technology are beneficial for reversed-phase liquid chromatography using highly aqueous mobile phases. For example, chromatographic materials described herein allow mitigating or preventing significant retention loss of reversed-phase liquid chromatography columns after flow interruption.

### RELATED APPLICATIONS

This application claims the benefit of U.S. Provisional Application No. 63/420,870, filed Oct. 31, 2022, the entire disclosure of which is incorporated herein by reference.

### FIELD OF THE TECHNOLOGY

The present technology generally relates to compositions, methods and devices having a multi-component chromatographic material useful for reversed-phase liquid chromatography. Particularly, the present technology relates to multi-component chromatographic materials including a chromatographic core having an exterior surface; and at least two different hydrophobic ligands covalently bound to the exterior surface.

### BACKGROUND

Reversed-phase liquid chromatography (RPLC) is one of the most widely used separation and analysis technology that is applicable to a wide variety of applications, ranging from the separation of small organic acids to large proteins.

Conventional reversed-phase columns employ a nonpolar stationary phase (most frequently a hydrocarbon chain chemically bonded to silica) and a polar mobile phase including water and at least a water-miscible organic solvent, which performs as a modifier. RPLC columns are primarily utilized to separate hydrophobic and moderately polar compounds. They may also be used to retain very polar compounds when using highly or near 100% aqueous mobile phases.

However, some drawbacks, including, for example, weak retention of ionic compounds and residual silanol activity which lead to peak tailing of basic analytes, prevent employment of conventional reversed-phase silica columns in certain applications.

One of the most practically significant limitation of RPLC is a dramatic retention volume or time loss after the column flow is stopped and resumed when using highly aqueous mobile phases with specific reversed-phase LC columns.

### SUMMARY

One of the objectives of the present disclosure is to improve the separation efficiency of reversed-phase columns when highly aqueous mobile phases including from about 98% to about 100% water.

The multi-component chromatographic materials of the present technology is useful for mitigating or preventing a dramatic retention volume or time loss after the column flow is stopped and resumed when using highly aqueous mobile phases.

The multi-component chromatographic materials of the present technology aids reducing receding contact angle of water on a stationary phase used in a reversed-phase liquid chromatography column compared to conventional reversed-phase stationary phases employed in a reversed-phase liquid chromatography column.

The present technology is directed to a multi-component chromatographic material including a chromatographic core having an exterior surface; and at least two different hydrophobic ligands covalently bound to the exterior surface, wherein the total surface coverage of the at least two different hydrophobic ligands is less than 2.0 μmol/m². In some embodiments, at least one hydrophobic ligand includes a cycloalkyl group.

In certain embodiments, at least one hydrophobic ligand includes an aromatic ring group e.g., a phenyl group.

In one aspect, provided herein is a multi-component chromatographic material including: a chromatographic core having an exterior surface; and at least two different hydrophobic ligands covalently bound to the exterior surface, wherein the total surface coverage of the at least two different hydrophobic ligands is less than 2.0 μmol/m², wherein at least two different hydrophobic ligands comprise a first hydrophobic ligand selected from C₄ to C₃₀ phenyl alkyl moiety, and a second hydrophobic ligand selected from C₄ to C₃₀ alkyl moiety.

The above aspect may include one or more of the following features. In some embodiments, the first hydrophobic ligand is phenylhexyl moiety and the second hydrophobic ligand is C₁₈ alkyl moiety. In some embodiments, the first hydrophobic ligand is phenylhexyl moiety and the second hydrophobic ligand is C₈ alkyl moiety.

In one aspect, provided herein is a multi-component chromatographic material including: a chromatographic core having an exterior surface; and at least two different hydrophobic ligands covalently bound to the exterior surface, wherein the total surface coverage of the at least two different hydrophobic ligands is less than 2.0 μmol/m², wherein at least two different hydrophobic ligands comprise a first hydrophobic ligand selected from C₄ to C₄₂ phenyl alkyl moiety, and a second hydrophobic ligand selected from C₄ to C₄₂ alkyl moiety.

In some embodiments, the first hydrophobic ligand is phenylhexyl moiety and the second hydrophobic ligand is selected from C₂₃ to C₄₂ alkyl moiety.

In some embodiments, the molar ratio of the first hydrophobic ligand to the second hydrophobic ligand is from about 4.5:1.0 to about 1.0:4.5. In some embodiments, the molar ratio of the first hydrophobic ligand to the second hydrophobic ligand is from about 2.5:1.0 to about 1.0:2.5. In some embodiments, the molar ratio of the first hydrophobic ligand to the second hydrophobic ligand is about 1.8:1.0. In some embodiments, the molar ratio of the first hydrophobic ligand to the second hydrophobic ligand is about 1.0:1.0.

In one aspect, provided herein is a multi-component chromatographic material including: a chromatographic core having an exterior surface; and at least two different hydrophobic ligands covalently bound to the exterior surface, wherein the total surface coverage of the at least two different hydrophobic ligands is less than 2.0 μmol/m², wherein the first hydrophobic ligand is C₁₈ alkyl moiety and the second hydrophobic ligand is C₈ alkyl moiety and the molar ratio of the first hydrophobic ligand to the second hydrophobic ligand is from about 2.0:1.0 to about 1.0:2.0.

In some embodiments, the molar ratio of the first hydrophobic ligand to the second hydrophobic ligand is about 1.0:1.0.

In another aspect, provided herein is a multi-component chromatographic material including: a chromatographic core having an exterior surface; and at least two different hydrophobic ligands covalently bound to the exterior surface, wherein the total surface coverage of the at least two different hydrophobic ligands is less than 2.0 μmol/m², wherein at least two different hydrophobic ligands comprise a first hydrophobic ligand selected from C₂₃ to C₄₂ alkyl moiety, and a second hydrophobic ligand selected from C₂₃ to C₄₂ alkyl moiety, wherein the number of carbon atoms of the second hydrophobic ligand is different than the number of carbon atoms of the first hydrophobic ligand.

In some embodiments, the molar ratio of the first hydrophobic ligand to the second hydrophobic ligand is from about 2.0:1.0 to about 1.0:2.0. In one embodiment, the molar ratio of the first hydrophobic ligand to the second hydrophobic ligand is about 1:1.

The above aspect may include one or more of the following features. In some embodiments, the chromatographic core is porous and the average diameter of the pores of the chromatographic core is less than 100 Å.

In some embodiments, the at least two different hydrophobic ligands are modified with an endcapping silane, e.g., trimethylsilane, to minimize and eliminate residual silanol activity.

In some embodiments, the chromatographic core includes a material selected from silica, alumina, titania, zirconia, and combinations thereof. In some embodiments, the chromatographic core includes a material selected from a silica monolith, a silica gel, a silica/organic polymer hybrid, a silica core/shell material, and a polymeric synthetic organic polymer. In one embodiment, the chromatographic core comprises an inorganic/organic hybrid material.

The present technology is also directed to a reversed-phase liquid chromatography column including a multi-component chromatographic material according to multiple embodiments described herein.

In one aspect, provided herein is a method for selectively isolating, separating or purifying one or more analyte(s) from a sample, the method including the steps of: a) loading a sample containing the one or more analyte(s) onto a chromatographic column including the multi-component chromatographic material according to multiple aspects and embodiments described herein, such that the one or more analyte(s) is selectively retained onto the multi-component chromatographic material; and b) eluting the retained analytes from the multi-component chromatographic material, thereby selectively isolating the one or more analyte(s) from the sample.

In some embodiments, the retained analytes are eluted from the multi-component chromatographic material using a mobile phase including from about 90% to about 100% water, from about 95% to about 100% water, from about 98% to about 100% water, from about 99% to about 100% water.

In another aspect, the present technology is directed to a method of reducing receding contact angle of water on a stationary phase used in a reversed-phase liquid chromatography column. The method includes: chromatographically separating a sample using the stationary phase including the multi-component chromatographic material according to multiple aspects and embodiments described herein, thereby reducing receding contact angle of water on the stationary phase to less than 90 degrees, wherein the chromatographic separation is performed using a mobile phase including from about 95% to about 100% water, from about 98% to about 100% water, from about 99% to about 100% water about 98% to about 100% water.

The materials and methods of the present technology provide numerous advantages.

For example, an advantage of materials and methods of the present technology is the decrease in the retention losses when flow rate is accidentally or deliberately stopped or resumed. By reducing retention losses, the materials and methods described herein improves selectivity and data reproducibility while separating polar compounds by using highly aqueous mobile phases. That is, the materials provided herein can be used to fabricate improved columns for reversed-phase separations of polar compounds. For example, the multi-component chromatographic material in the stationary phase described herein provides a desirable interface disorder that enables better peak separation and improved resolution.

The materials of the present technology can be effectively used at high temperatures (e.g., above 25° C. up to 80° C.) as well as low temperatures (e.g., 25° C. or below). Conditions at high temperatures are the most challenging conditions in terms of dewetting, as dewetting is much faster at high temperatures than at low temperatures.

A further advantage of at least some of the embodiments of the present disclosure is that the materials provided herein may be used in short trapping RPLC columns which are difficult to keep wetted because of their low pressure drop.

Not necessarily all such aspects or advantages are achieved by any particular embodiment. Thus, various embodiments may be carried out in a manner that achieves or optimizes one advantage or group of advantages taught herein without necessarily achieving other aspects or advantages as may also be taught or suggested herein.

### BRIEF DESCRIPTION OF THE DRAWINGS

The technology will be more fully understood from the following detailed description taken in conjunction with the accompanying drawings, in which:

FIG. 1A, FIG. 1B and FIG. 1C show exemplary combinations of two different hydrophobic ligands including a first hydrophobic ligand and a second hydrophobic ligand. FIG. 1A shows exemplary combination of two different hydrophobic ligands including at least one hydrophobic ligand that includes an aromatic ring group, e.g., a phenyl group. FIG. 1B shows exemplary combination of two different hydrophobic ligands, including, alkyl chains. FIG. 1C shows exemplary combination of two different hydrophobic ligands including at least one hydrophobic ligand that includes a cycloalkyl group.

FIG. 2 shows exemplary aromatic ring groups that can be included in the first hydrophobic ligand of the present disclosure.

FIG. 3 shows Laplace equation that relates the pressure causing dewetting with the contact angle of water.

FIG. 4A, FIG. 4B and FIG. 4C illustrate retention time of thymine after stopping the flow for 64 minutes and then restarting it. The amount of decrease in the retention time is directly related to dewetting percentage of the exterior surface. FIG. 4A shows dewetting of 100 Angstrom silica particles bonded with a pure C₁₈ bonded phase with a surface concentration of 1.5 micromoles per square meter. FIG. 4B shows dewetting of 100 Angstrom silica particles bonded with single component phenylhexyl with a surface concentration of 1.5 micromoles per square meter. FIG. 4C shows dewetting of 100 Angstrom silica particles bonded with two-component phenylhexyl/C₁₈ with a surface concentration of 1.5 micromoles per square meter.

FIG. 5A shows the effect of molar ratio of phenylhexyl/C₁₈ and temperature (24° C. and 60° C.) on the fraction of the surface area that remains wetted after stopping the flow for 1 hour, then restarting. Two-component phenylhexyl/C₁₈ ligands are bonded to 100 Angstrom silica particles with a surface concentration of 1.5 micromoles per square meter. FIG. 5B shows the effect of the time that the flow was stopped and temperature (24° C. and 60° C.) on the wetted surface area of 97 Angstrom silica particles bonded with two-component long alkyl groups (e.g., alkyl groups having at least 18 carbons such as C₁₈ and C₃₀) with a surface concentration of 0.85 micromoles per square meter.

### DETAILED DESCRIPTION

Reversed-phase liquid chromatography is widely known in the art for separating a water-soluble compound, using a mobile phase as a solvent that solves a sample to be separated, and a stationary phase as a liquid or a solid that is carried by a packing material (i.e., a carrier) that packs a column.

The mobile phase contains water as its main component (95% water or more), and the stationary phase generally contains a compound having a carbon chain. When a mobile phase containing water as its main component is used with a reversed-phase stationary phase to which an alkyl group (generally having from 8 to 18 carbons) is bonded, time of retention of sample is generally not stable, and the retention time decreases as the time in which the mobile phase is flowed increases. This phenomenon decreases the reproducibility of the retention time.

In particular, in the case where the flow of the mobile phase is resumed after it is temporarily stopped, it is known that the retention time significantly decreases. Since, in the chromatography, the compound separated is identified based on the retention time, the mobile phase cannot be used with the stationary phase if the reproducibility of retention time is low. Conventionally, it has been speculated that the reason why the reproducibility of retention time is low is that when the mobile phase containing water as its main component is flowed through the stationary phase, the carbon chains gradually collapse due to their hydrophobicity and so-called “phase collapse” occurs. That is, the interaction between the stationary phase and the solute decreases.

However, this phenomenon is now explained as a process of “pore dewetting” with the expulsion of water from the hydrophobic pore network. Recent studies have demonstrated that the phenomenon is fundamentally explained by pore dewetting, where water confined in hydrophobic mesopores is no longer at thermodynamic equilibrium with its vapor when the flow is suddenly stopped, and the column returns to atmospheric pressure. The driving force for this process is the instability of the water liquid/vapor biphasic system when water is confined in hydrophobic mesopores with diameters <50 nm. Water is forced to leave the mesopore space in porous reversed-phase LC materials by the pressure difference between the vapor and liquid phases (also known as Laplace pressure). While the pore-dewetting phenomenon can occur with mobile phases containing <100% water, it becomes more significant when a 100% aqueous mobile phase is used.

The kinetics of pore dewetting depends on several parameters including but not limited to column pressure, pore size and structure of the stationary phase material, mobile phase temperature, surface chemistry of the stationary phase material, surface concentrations and molecular ordering of bonded ligands on the surface of the stationary phase material, dissolved gases in mobile phase etc.

It is therefore an object of the present technology to provide an a reversed-phase liquid chromatography in which a mobile phase containing water as its main component (higher than 95% water) can be used with any sort of column, and a multi-component chromatographic material for use in that reversed-phase liquid chromatography.

In this disclosure, extensive studies have been carried out to find out new chromatographic materials that alters the kinetics of dewetting process and slows down dewetting of water in the case where flow of a mobile phase is resumed or stopped.

The multi-component chromatographic materials provided herein allows the diminution of the receding contact angle, thereby contributing to slow down water dewetting kinetics.

In one aspect, provided herein is multi-component chromatographic material comprising: a chromatographic core having an exterior surface; and at least two different hydrophobic ligands covalently bound to the exterior surface, wherein the total surface coverage of the at least two different hydrophobic ligands is less than 2.0 μmol/m².

As used herein, the term “hydrophobic ligand” includes a surface ligand on the exterior surface of the chromatographic core which exhibits hydrophobicity. The hydrophobic ligand of the present technology is covalently attached to the exterior surface of the chromatographic core.

As used herein, the term “covalent attachment” means that the two elements described are either directly covalently joined to each other (e.g., via a carbon-carbon bond), or are indirectly covalently joined to one another via an intervening chemical structure, such as a bridge, spacer, linker, linkage group, or any combination thereof. The term “bridge” refers to a molecular fragment that connects two distinct chemical elements. The terms “spacer” or “linker” are used interchangeably to refer to a single covalent bond or series of stable covalent bonds incorporating 1-30 nonhydrogen atoms selected from the group consisting of C, N, O, S, and P that covalently connect two or more distinct chemical elements. The term “linkage group” is intended to mean a chemical functional group capable of covalently joining two or more chemical elements (e.g., a phosphoryl or sulfonyl group).

As used herein, “chromatographic surface” includes a surface which provides for chromatographic separation of a sample. In certain embodiments, the chromatographic surface is porous (e.g., having a pore volume of 0.1 cc/g, to 1.5 cc/g). In some embodiments, a chromatographic surface can be the surface of a particle, a superficially porous material or a monolith. In certain embodiments, the chromatographic surface is composed of the surface of one or more particles, superficially porous materials or monoliths used in combination during a chromatographic separation. In certain other embodiments, the chromatographic surface is non-porous (e.g., having a pore volume of less than 0.1 cc/g, such as 0.05 cc/g).

The chromatographic surface of the present technology includes (a) functional group(s) that aids covalent attachment of the hydrophobic ligands on the exterior surface of the chromatographic core.

The above aspect may include one or more of the following features. In some embodiments, at least two different hydrophobic ligands comprise a first hydrophobic ligand selected from C₄ to C₂₄ alkyl moiety, and a second hydrophobic ligand selected from C₄₊ₙ to C₂₄₊ₙ alkyl moiety, wherein n is at least 10 and the number of carbon atoms of the second hydrophobic ligand is at least 10 carbon atoms greater than the number of carbon atoms of the first hydrophobic ligand.

In some embodiments, at least two different hydrophobic ligands comprise a first hydrophobic ligand selected from C₁₈ to C₄₂ alkyl moiety, and a second hydrophobic ligand selected from C₁₈ to C₄₂ alkyl moiety, wherein the number of carbon atoms of the second hydrophobic ligand is different than the number of carbon atoms of the first hydrophobic ligand.

In some embodiments, at least two different hydrophobic ligands comprise a first hydrophobic ligand selected from C₂₃ to C₄₂ alkyl moiety, and a second hydrophobic ligand selected from C₂₃ to C₄₂ alkyl moiety, wherein the first hydrophobic ligand is different from the second hydrophobic ligand.

In some embodiments, at least two different hydrophobic ligands comprise a first hydrophobic ligand selected from C₄ to C₃₀ phenyl alkyl, and a second hydrophobic ligand selected from C₄ to C₃₀ alkyl moiety, wherein the first hydrophobic ligand is different from the second hydrophobic ligand.

In one embodiment, the first hydrophobic ligand is phenylhexyl moiety and the second hydrophobic ligand is C₈ alkyl moiety.

In another embodiment, the first hydrophobic ligand is phenylhexyl moiety and the second hydrophobic ligand is C₁₈ alkyl moiety.

In some embodiments, at least two different hydrophobic ligands comprise a first hydrophobic ligand selected from C₄ to C₄₂ phenyl alkyl, and a second hydrophobic ligand selected from C₄ to C₄₂ alkyl moiety, wherein the first hydrophobic ligand is different from the second hydrophobic ligand.

In some embodiments, at least two different hydrophobic ligands comprise a first hydrophobic ligand selected from C₂₃ to C₄₂ phenyl alkyl, and a second hydrophobic ligand selected from C₂₃ to C₄₂ alkyl moiety, wherein the first hydrophobic ligand is different from the second hydrophobic ligand.

In some embodiments, at least two different hydrophobic ligands comprise a first hydrophobic ligand selected from C₁₈ to C₄₂ phenyl alkyl, and a second hydrophobic ligand selected from C₁₈ to C₄₂ alkyl moiety, wherein the first hydrophobic ligand is different from the second hydrophobic ligand.

In some embodiments, at least two different hydrophobic ligands comprise a first hydrophobic ligand selected from C₄ to C₆₀ including a cycloalkyl group, and a second hydrophobic ligand selected from C₄ to C₄₂ alkyl moiety, wherein the first hydrophobic ligand is different from the second hydrophobic ligand.

As used herein, “cycloalkyl” refers to a saturated aliphatic carbocyclic group. Typical cycloalkyl groups include, but are not limited to, cyclopropyl, cyclobutyl, cyclopentyl, cyclohexyl and the like. C₄ to C₆₀ including a cycloalkyl group used in the present disclosure refers to an alkyl chain attached to a cycloalkyl group, wherein total number of carbons in the ligand is between 4 and 60.

In some embodiments, at least two different hydrophobic ligands comprise a first hydrophobic ligand selected from C₄ to C₆₀ including an aromatic ring, and a second hydrophobic ligand selected from C₄ to C₄₂ alkyl moiety, wherein the first hydrophobic ligand is different from the second hydrophobic ligand.

As used herein, “aromatic ring” or “aryl” refers to a fully unsaturated carbocyclic ring whose planar ring has a delocalized π electron system and contains 4n+2 π electrons, where n is an integer. The aromatic ring can be composed of six, eight, ten, or more than ten carbon atoms, and the aromatic ring can be monocyclic or polycyclic. Common aromatic rings include but are not limited to benzene ring, naphthalene ring, phenanthrene ring, anthracene ring, fluorene ring and indene ring. C₄ to C₆₀ including an aromatic group used in the present disclosure refers to an alkyl chain attached to an aromatic group, wherein total number of carbons in the ligand is between 4 and 60.

In some embodiments, aromatic groups include 5- and 6-membered single-ring groups which can include from zero to four heteroatoms, for example, furan, pyrrole, pyrroline, oxazole, thiazole, imidazole, imidazoline, pyrazole, pyrazoline, pyrazolidine, isoxazole, isothiazole, benzene, pyridine, pyridazine, pyrimidine, pyrazine, triazine, thiophene and the like. The aromatic ring can be substituted at one or more ring positions with, for example, a halogen, a lower alkyl, a lower alkenyl, a lower alkoxy, a lower alkylthio, a lower alkylamino, a lower alkylcarboxyl, a nitro, a hydroxyl, —CF3, —CN, or the like. In other embodiments, aromatic groups include 5- and 6-membered multiple-ring groups which can include from zero to eight heteroatoms, for example, indene, indolinzine, indole, isoindole, indoline, indazole, benzimidazole, benzthiazole, naphthalene, quinolizine, quinoline, isoquinoline, cinnoline, phthalazine, quinazoline, quinoxaline, 1,8-naphthyridine, quinuclidine, fluorene, carbazole, anthracene, acridine, phanazine, phenothiazine, phenoxazine, pyrene, and the like. Polyaromatic groups include fused aromatic groups.

Cycloalkyl groups and aromatic rings, e.g., a phenyl, disclosed herein may include a heteroatom. As used herein, “heteroatom” refers to any atom other than a carbon atom that can be covalently bonded to a carbon atom. Common heteroatoms include but are not limited to O, S, and N.

As used herein, the term “alkyl” includes saturated aliphatic groups, including straight-chain alkyl groups, branched-chain alkyl groups, cycloalkyl (alicyclic) groups, alkyl substituted cycloalkyl groups and cycloalkyl substituted alkyl groups.

Moreover, the term “alkyl” as used throughout the present disclosure includes both “unsubstituted alkyls” and “substituted alkyls,” the latter of which refers to alkyl moieties having substituents replacing a hydrogen on one or more carbons of the hydrocarbon backbone. Such substituents can include, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety. It will be understood by those skilled in the art that the moieties substituted on the hydrocarbon chain can themselves be substituted, if appropriate.

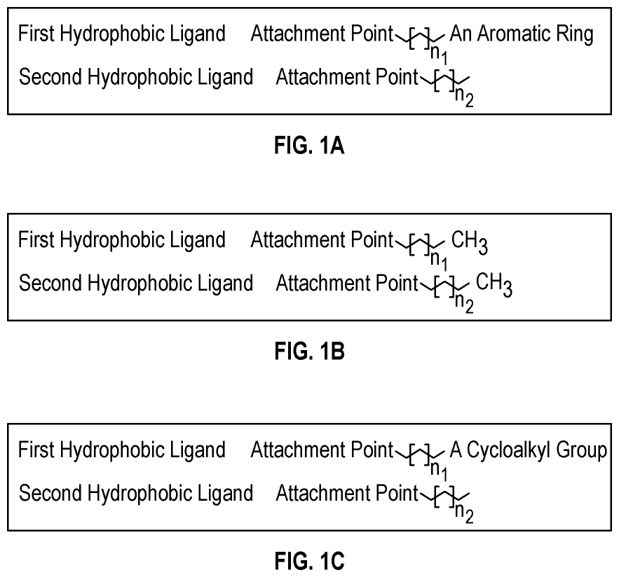

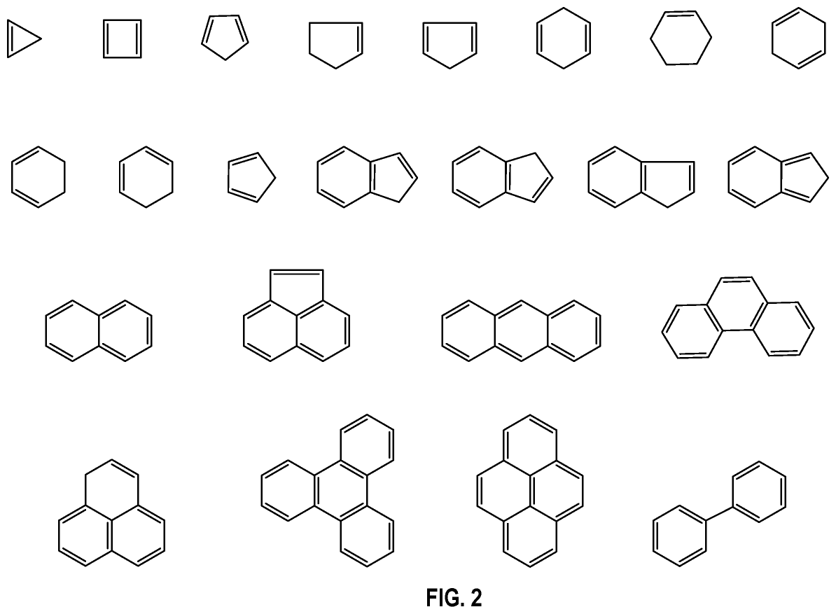

FIG. 1A, FIG. 1B and FIG. 1C show exemplary combinations of two different hydrophobic ligands including a first hydrophobic ligand and a second hydrophobic ligand. As shown in FIG. 1A, in some embodiments, at least one hydrophobic ligand includes an aromatic ring group, e.g., a phenyl group. Exemplary aromatic ring groups that can be included in the first hydrophobic ligand are shown in FIG. 2.

In some embodiments, the number of carbon atoms of the second hydrophobic ligand (n₂) and the number of carbon atoms of the second hydrophobic ligand (n₂) shown in FIG. 1A-FIG. 1C is selected independently. In some embodiments, n₁ is equal to n₂. In other embodiments, n₁ and n₂ are different than each other.

In some embodiments, the number of carbon atoms in the alkyl chain of the first hydrophobic ligand (n₁) shown in FIG. 1A is between 4 and 42, between 4 and 30, between 4 and 18.

In some embodiments, the number of carbon atoms in the alkyl chain of the first hydrophobic ligand (n₁) shown in FIG. 1A is between 23 and 42.

In some embodiments, the number of carbon atoms in the alkyl chain of the second hydrophobic ligand (n₂) shown in FIG. 1A is between 4 and 42, between 4 and 30, between 4 and 18.

In some embodiments, the number of carbon atoms in the alkyl chain of the second hydrophobic ligand (n₂) shown in FIG. 1A is between 23 and 42.

In some embodiments, the number of carbon atoms in the alkyl chain of the first hydrophobic ligand (n₁) shown in FIG. 1B is between 4 and 42, between 4 and 30, between 4 and 18, between 18 and 42, between 23 and 42.

In some embodiments, the number of carbon atoms in the alkyl chain of the second hydrophobic ligand (n₂) shown in FIG. 1B is between 4 and 42, between 4 and 30, between 4 and 18, between 18 and 42, between 23 and 42.

In some embodiments, the number of carbon atoms of the second hydrophobic ligand (FIG. 1B, n₂) is at least 10 carbon atoms greater than the number of carbon atoms of the first hydrophobic ligand (FIG. 1B, n₁).

As shown in FIG. 1C, in some embodiments, at least one hydrophobic ligand includes a cycloalkyl group.

In some embodiments, the number of carbon atoms in the alkyl chain of the first hydrophobic ligand (n₁) shown in FIG. 1C is between 4 and 42, between 4 and 30, between 4 and 18, between 18 and 42, between 23 and 42.

In some embodiments, the number of carbon atoms in the alkyl chain of the second hydrophobic ligand (n₂) shown in FIG. 1C is between 4 and 42, between 4 and 30, between 4 and 18, between 18 and 42, between 23 and 42.

The molar ratio of the first hydrophobic ligand and the second hydrophobic ligand of the present technology that covalently bound to the exterior surface of the chromatographic core may vary independently. In some embodiments, the molar number of the first hydrophobic ligand and the second hydrophobic ligand present on the exterior surface of the chromatographic core is same. In some embodiments, the molar number of the first hydrophobic ligand and the second hydrophobic ligand present on the exterior surface of the chromatographic core is different.

In some embodiments, the molar ratio of the first hydrophobic ligand to the second hydrophobic ligand is from about 5.0:1.0 to about 1.0:5.0.

In some embodiments, the molar ratio of the first hydrophobic ligand to the second hydrophobic ligand is from about 2.5:1.0 to about 1.0:2.5.

In some embodiments, the molar ratio of the first hydrophobic ligand to the second hydrophobic ligand is from about 1.5:1.0 to about 1.0:1.5.

In some embodiments, the molar ratio of the first hydrophobic ligand to the second hydrophobic ligand is about 1.0:1.0.

In some embodiments, the at least one hydrophobic ligand is modified with an endcapping silane. In other embodiments, the at least two different hydrophobic ligands are modified with an endcapping silane.

As used herein, the term “endcapping” means the placement of functional groups at the ends of the chain. In some embodiments, the endcapping silane is selected from methyl hydrosilane, methyl dihydrosilane, dimethyl hydrosilane and mixtures thereof.

In some embodiments, the endcapping silane is trimethylsilane.

In some embodiments, the chromatographic core of the present technology includes a material selected from silica, alumina, titania, zirconia, and combinations thereof.

As used herein, the term “chromatographic core” includes chromatographic materials, including but not limited to an organic material such as silica or a hybrid material, as defined herein, in the form of a particle, a monolith or another suitable structure which forms an internal portion of the materials of the present disclosure. In certain aspects, the exterior surface of the chromatographic core represents the chromatographic surface, as defined herein, or represents a material encased by a chromatographic surface, as defined herein. The chromatographic surface material can be disposed on or bonded to or annealed to the chromatographic core in such a way that a discrete or distinct transition is discernible or can be bound to the chromatographic core in such a way as to blend with the surface of the chromatographic core resulting in a gradation of materials and no discrete internal core surface. In certain embodiments, the chromatographic surface material can be the same or different from the material of the chromatographic core and can exhibit different physical or physiochemical properties from the chromatographic core, including, but not limited to, pore volume, surface area, average pore diameter, carbon content or hydrolytic pH stability.

In some embodiments, the chromatographic core includes a material selected from a silica monolith, a silica gel, a silica/organic polymer hybrid, a silica core/shell material, and a polymeric synthetic organic polymer.

The term, “core/shell material” refers to a material including a core portion and a shell portion surrounding the core portion. In some embodiments, the chromatographic core includes a core/shell material.

In some embodiments, the chromatographic core comprises an inorganic/organic hybrid material.

As used herein the term “inorganic/organic hybrid material,” includes inorganic-based structures wherein an organic functionality is integral to both the internal or “skeletal” inorganic structure as well as the hybrid material surface. The inorganic portion of the hybrid material can be, e.g., alumina, silica, titanium, cerium, or zirconium or oxides thereof, or ceramic material. Exemplary hybrid materials are described in U.S. Pat. Nos. 4,017,528; 6,528,167; 6,686,035; 7,919,177; and 7,175,913.

In some embodiments, the chromatographic core is porous and may have a pore size ranging from 20 Å or less to 200 Å or more, for example, ranging anywhere from 20 to 100, from 50 to 100, from 100 to 200 Å. Porous materials are defined herein as having a pore volume of 0.2 cc/g or greater (e.g., 0.2 cc/g to about 1.5 cc/g). Pore volume is measured using methods known in the art based on multi point nitrogen sorption experiments (e.g., Micromeritics ASAP 2400, Micromeritics Instruments Inc., Norcross, GA).

In some embodiments, the average diameter of the pores of the chromatographic core is less than 100 Å and has a pore volume between 0.2 cc/g and 1.5 cc/g.

In one aspect, provided herein is a reversed-phase liquid chromatography column including a multi-component chromatographic material according to various aspects and embodiments of the present technology.

In another aspect, the present technology is directed to a method for selectively isolating, separating or purifying one or more analyte(s) from a sample using the multi-component chromatographic material according to various aspects and embodiments of the present technology.

As used herein, the terms “purifying,” “separating,” or “isolating,” as used interchangeably herein, refer to increasing the degree of purity of a target molecule from a composition or sample matrix, e.g., a solution comprising the target molecule and one or more impurities. Typically, the degree of purity of the target molecule is increased by removing (completely or partially) at least one impurity from the composition.

The reversed-phase liquid chromatography column of the present technology can be used to retain, separate and/or analyze a plurality of different compounds of interest from many different samples from many different fields, for example, from clinical chemistry, medicine, veterinary medicine, forensic chemistry, pharmacology, food industry, safety at work, and environmental pollution. The plurality of samples including, but are not limited to, small organic molecules, proteins, nucleic acids, lipids, fatty acids, carbohydrates, polymers, and the like. Similarly, the present disclosure can be used for the separation of small molecules, polar small molecules, analytes used in pharmaceuticals, biomolecules, antibodies, polymers and oligomers, sugars, glycan analysis, petrochemical analysis, lipid analysis, peptides, phosphopeptides, oligonucleotides, DNA, RNA, polar acids, polyaromatic hydrocarbons, food analysis, chemical analysis, bioanalysis, drugs of abuse, forensics, pesticides, agrochemicals, biosimilars, formulations.

Analytes amenable to chromatographic separation with the present disclosure can include essentially any molecule of interest, including, for example, small organic molecules, lipids, peptides, nucleic acids, synthetic polymers.

In one aspect, the present technology is directed to a method for selectively isolating, separating or purifying one or more analyte(s) from a sample, the method comprising the steps of: a) loading a sample containing the one or more analyte(s) onto a chromatographic column comprising the multi-component chromatographic material of the present technology, such that the one or more analyte(s) is selectively retained onto the multi-component chromatographic material; and b) eluting the retained analytes from the multi-component chromatographic material, thereby selectively isolating the one or more analyte(s) from the sample.

In some embodiments, the retained analytes are eluted from the multi-component chromatographic material using a highly aqueous mobile phase. As used herein, highly aqueous mobile phase refers to a mobile phase comprising from about 95% to about 100% water, from about 98% to about 100% water.

In another aspect, provided herein is a method of reducing receding contact angle of water on a stationary phase used in a reversed-phase liquid chromatography column including: chromatographically separating a sample using the stationary phase comprising the multi-component chromatographic material of the present technology, thereby reducing receding contact angle of water on the stationary phase to less than 90 degrees.

Without wishing to be bound by the theory, as receding contact angle decreases, the driving force for water dewetting is expected to decrease, thereby retention loss is decreased.

In some embodiments, the chromatographic separation is performed using a mobile phase comprising from about 98% to about 100% water.

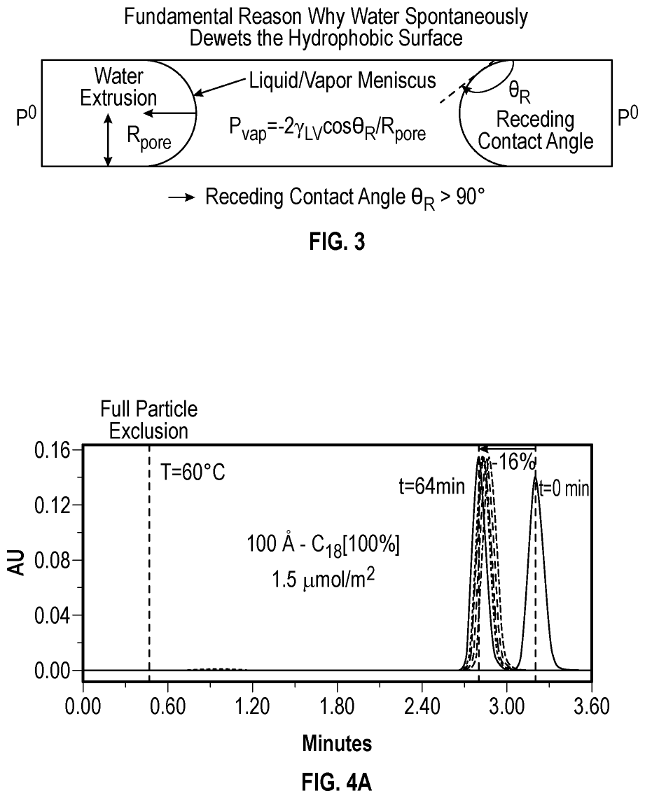

Recent studies in the field have demonstrated that the retention loss observed in reversed-phase chromatography column is fundamentally explained by pore dewetting, where water confined in hydrophobic mesopores is no longer at thermodynamic equilibrium with its vapor when the flow is suddenly stopped, and the column returns to atmospheric pressure. The equilibrium water vapor pressure, Pvap, is given by the Laplace equation (FIG. 3). Pᵥₐₚ depends on the receding contact angle of water on the hydrophobic surface (θ˜93°), the liquid/vapor surface tension of water (γLV=72 mN/m), and the mesopore radius (Rpore˜50 Å); therefore, it is typically around 10 to 20 bar. The pressure difference, Pᵥₐₚ−P₀˜Pᵥₐₚ, is the driving force for liquid water to be spontaneously extruded from the mesopore network. The receding process ends when the water has entirely left the pores to reach thermodynamic equilibrium. The kinetics of this process depends on several experimental parameters including but not limited to temperature, column pressure, pore size distribution and pore size of the chromatographic material, surface coverage of the chromatographic surface, surface chemistry of the chromatographic surface, dissolved gases in mobile phase.

### EXAMPLES

The following examples are included to demonstrate preferred embodiments of the invention.

### Example 1. Dewetting of Single Hydrophobic Ligands (C₁₈, Phenylhexyl) and Mixed Hydrophobic Ligands (C₁₈, Phenylhexyl)

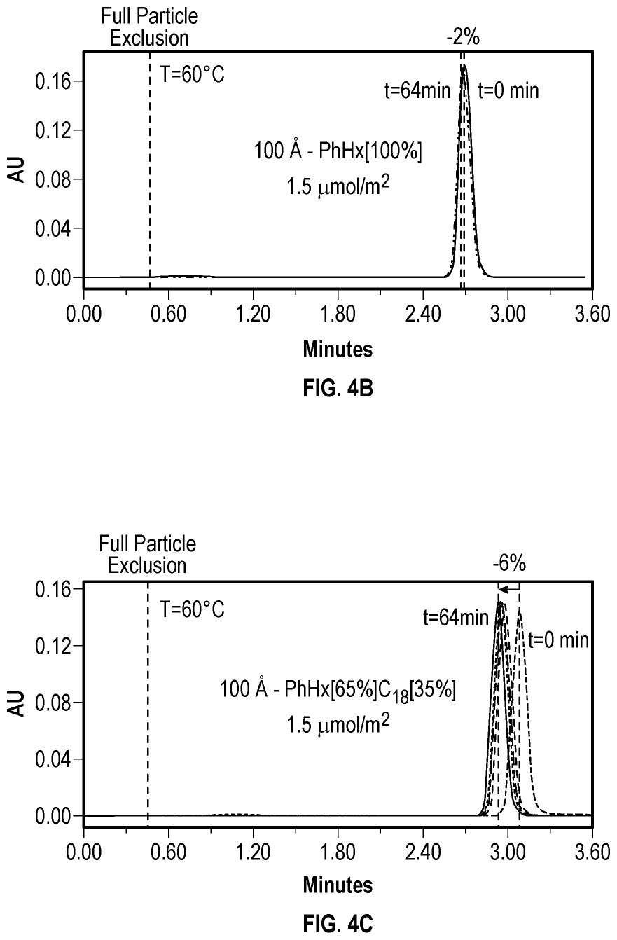

Experiments showed that a pure C₁₈ bonded phase with a surface concentration of 1.5 micromoles per square meter (FIG. 4A) shows 16% dewetting. A single component phenylhexyl bonded phase with a surface concentration of 1.5 micromoles per square meter (FIG. 4B) shows only 2% dewetting. FIG. 4C were obtained using a two-component phenylhexyl/C₁₈ bonded phase, with a total surface concentration of 1.5 micromoles per square meter. The two-component phenylhexyl/C₁₈ bonded phase system provides 6% dewetting.

Dewetting percentages were calculated using equation 1 and 2. The mathematical expression for % Dewetting of the exterior surface is:

% Dewet=(t_{R,after}−tₑ)/(t_{R,before}−tₑ) Equation (1)

where t_{R,after} is the retention time observed after the flow rate was stopped and resumed, t_{R,before} is the retention time observed before the flow rate was stopped when water was in contact with the entire “exterior” surface of the solid adsorbent, and t e is the inter-particle elution time given by:

tₑ=(epsilonₑ×π×r_{c}²×L)/Fᵥ Equation (2)

where epsilonₑ is the inter-particle volume fraction in a chromatography column, π is 3.1415926, r_{c} is the inner column radius, L is the column length, and Fᵥ is the flow rate applied to the column.

Although dewetting of single phenylhexyl bonded material show better results in terms of dewetting (FIG. 4B) compared to the two-component phenylhexyl/C₁₈ bonded phase (FIG. 4C), the present technology benefits from the mixed ligand technology. The present advantage of the two-component phenylhexyl/C₁₈ lies in the higher retentivity of that stationary phase relative to pure phenylhexyl. This will provide more retention of highly polar compounds such as thymine.

### Example 2. Dewetting after 1 Hour Flow Interruption

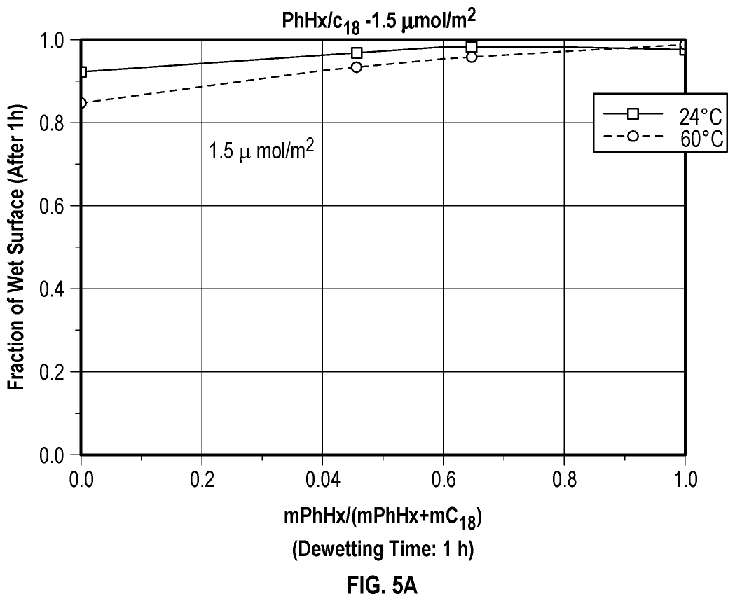

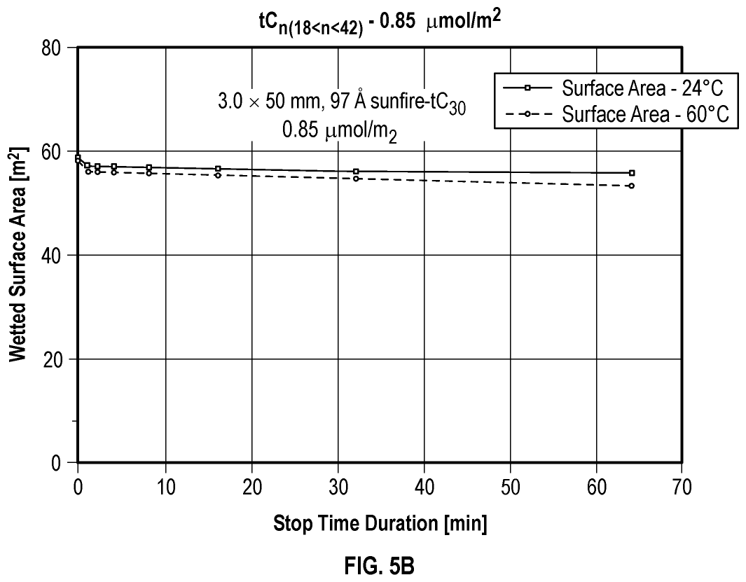

Using the same multi-component chromatographic material and set up as example 1, the effect of flow interruption was investigated. The Y-axis of FIG. 5A shows the fraction of the surface area that remains wetted after stopping the flow for 1 hour, then restarting. Values close to 1 indicate very little dewetting, which is desirable for RPLC. Results obtained at both 24 and 60 degrees Celsius are shown in FIG. 5A, with the 60 degrees being the most challenging condition because dewetting is much faster at high temperatures (e.g., above 25° C. up to 80° C.) than at low temperatures (e.g., 25° C. or below). For FIG. 5A, very little dewetting was achieved for any combination of phenylhexyl and C₁₈ groups with a total surface concentration of 1.5 micromoles per square meter, with a slight improvement as the fraction of phenylhexyl groups is increased.

### Example 3. The Effect of Flow Interruption on Dewetting

The mixture of long alkyl groups are bonded to the exterior surface at 0.85 micromoles per square meter (FIG. 5B). The chart (FIG. 5B) shows the wetted surface area on the y-axis versus the time that the flow was stopped on the x-axis. Very little dewetting was observed for this material, even after 64 minutes of stoppage at 60 degrees Celsius.

It should be appreciated by those of skill in the art that the techniques disclosed in the examples which follow represent techniques discovered by the inventor to function well in the practice of the invention, and thus can be considered to constitute preferred modes for its practice.

1. A multi-component chromatographic material comprising:
a chromatographic core having an exterior surface; and
at least two different hydrophobic ligands covalently bound to the exterior surface, wherein the total surface coverage of the at least two different hydrophobic ligands is less than 2.0 μmol/m², wherein at least two different hydrophobic ligands comprise a first hydrophobic ligand selected from C₄ to C₃₀ phenyl alkyl moiety, and a second hydrophobic ligand selected from C₄ to C₃₀ alkyl moiety.

2. The multi-component chromatographic material of claim 1, wherein the first hydrophobic ligand is phenylhexyl moiety and the second hydrophobic ligand is C₁₈ alkyl moiety.

3. The multi-component chromatographic material of claim 1, wherein the first hydrophobic ligand is phenylhexyl moiety and the second hydrophobic ligand is C₈ alkyl moiety.

4. The multi-component chromatographic material of claim 1, wherein the molar ratio of the first hydrophobic ligand to the second hydrophobic ligand is from about 2.5:1.0 to about 1.0:2.5.

5. The multi-component chromatographic material of claim 4, wherein the molar ratio of the first hydrophobic ligand to the second hydrophobic ligand is about 1.8:1.0.

6. The multi-component chromatographic material of claim 1, wherein the chromatographic core is porous and the average diameter of the pores of the chromatographic core is less than 100 Å.

7. A reversed-phase liquid chromatography column comprising a multi-component chromatographic material of claim 1.

8. A method for selectively isolating, separating or purifying one or more analyte(s) from a sample, the method comprising the steps of:
a) loading a sample containing the one or more analyte(s) onto a chromatographic column comprising the multi-component chromatographic material of claim 1, such that the one or more analyte(s) is selectively retained onto the multi-component chromatographic material; and
b) eluting the retained analytes from the multi-component chromatographic material, thereby selectively isolating the one or more analyte(s) from the sample.

9. The method of claim 8, wherein the retained analytes are eluted from the multi-component chromatographic material using a mobile phase comprising from about 98% to about 100% water.

10. A method of reducing receding contact angle of water on a stationary phase used in a reversed-phase liquid chromatography column comprising:
chromatographically separating a sample using the stationary phase comprising the multi-component chromatographic material of claim 1, thereby reducing receding contact angle of water on the stationary phase to less than 90 degrees, wherein the chromatographic separation is performed using a mobile phase comprising from about 98% to about 100% water.

11. A multi-component chromatographic material comprising:
a chromatographic core having an exterior surface; and
at least two different hydrophobic ligands covalently bound to the exterior surface, wherein the total surface coverage of the at least two different hydrophobic ligands is less than 2.0 μmol/m², wherein the first hydrophobic ligand is C₁₈ alkyl moiety and the second hydrophobic ligand is C₈ alkyl moiety and the molar ratio of the first hydrophobic ligand to the second hydrophobic ligand is from about 2.0:1.0 to about 1.0:2.0.

12. The multi-component chromatographic material of claim 11, wherein the molar ratio of the first hydrophobic ligand to the second hydrophobic ligand is about 1.0:1.0.

13. The multi-component chromatographic material of claim 11, wherein the at least two different hydrophobic ligands are modified with an endcapping silane.

14. The multi-component chromatographic material of claim 13, wherein the endcapping silane is trimethylsilane.

15. The multi-component chromatographic material of claim 11, wherein the chromatographic core comprises a material selected from silica, alumina, titania, zirconia, and combinations thereof.

16. The multi-component chromatographic material of claim 15, wherein the chromatographic core comprises a material selected from a silica monolith, a silica gel, a silica/organic polymer hybrid, a silica core/shell material, and a polymeric synthetic organic polymer.

17. The multi-component chromatographic material of claim 16, wherein the chromatographic core comprises an inorganic/organic hybrid material.

18. A multi-component chromatographic material comprising:
a chromatographic core having an exterior surface; and
at least two different hydrophobic ligands covalently bound to the exterior surface, wherein the total surface coverage of the at least two different hydrophobic ligands is less than 2.0 μmol/m², wherein at least two different hydrophobic ligands comprise a first hydrophobic ligand selected from C₂₃ to C₄₂ alkyl moiety, and a second hydrophobic ligand selected from C₂₃ to C₄₂ alkyl moiety, wherein the number of carbon atoms of the second hydrophobic ligand is different than the number of carbon atoms of the first hydrophobic ligand.

19. The multi-component chromatographic material of claim 18, wherein the molar ratio of the first hydrophobic ligand to the second hydrophobic ligand is from about 2.0:1.0 to about 1.0:2.0.

20. The multi-component chromatographic material of claim 19, wherein the molar ratio of the first hydrophobic ligand to the second hydrophobic ligand is about 1:1.
